(19) United States
(12) Patent Application Publication
(10) Pub. No.: US 2026/0058371 A1
(43) Pub. Date: Feb. 26, 2026

(54) FOLDED ANTENNA DIPOLE WITH ON-SUBSTRATE PASSIVE RADIATORS

(71) Applicant: JOHN MEZZALINGUA ASSOCIATES, LLC, Liverpool, NY (US)

(72) Inventor: Lance BAMFORD, Pittsford, NY (US)

(21) Appl. No.: 19/103,640

(22) PCT Filed: Aug. 17, 2023
(86) PCT No.: PCT/US2023/030447

§ 371 Date: Feb. 13, 2025

Related U.S. Application Data
(60) Provisional application No. 63/398,592, filed on Aug. 17, 2022.

(51) Int. Cl. H01Q 9/26; H01Q 5/30

(52) U.S. Cl. CPC H01Q 9/26; H01Q 5/30

(57) ABSTRACT

A scalable folded dipole has an additional passive conductor feature disposed on the same substrate (such as a PCB) as the conductor pattern forming the folded dipole's arms. The passive conductor feature is placed in an open region in a gap between adjacent dipole arms. The presence of the passive conductor feature provides for improved tuning of the gaps between adjacent dipole arms as well as improved impedance matching.

### CROSS REFERENCE TO RELATED APPLICATIONS

This application claims the benefit of priority to U.S. Provisional Patent Application No. 63/398,592, filed Aug. 17, 2022, which is incorporated by reference int its entirety.

### BACKGROUND OF THE DISCLOSURE

### Field of the Invention

The present invention relates to wireless communications, and more particularly, to folded antenna dipoles.

### Related Art

Folded dipoles find use in multiband cellular antennas that have subarrays of dipoles of different frequency bands placed in close proximity. Folded dipoles have a particular advantage in these deployments because they provide for sufficient gain and bandwidth for the frequency band in question, while minimizing the footprint of the dipole, and thereby reducing inter-band interference with neighboring dipoles of other frequency bands. However, conventional folded dipoles may suffer from inadequate tuning and insufficient input impedance matching for single element environments where the input match becomes critical for the overall system performance.

Accordingly, what is needed is a folded dipole that can be scaled to operate in different frequency bands and has improved performance and input impedance matching.

### SUMMARY OF THE DISCLOSURE

An aspect of the present disclosure involves a folded dipole. The folded dipole comprises a substrate; and a conductor pattern disposed on the substrate, the conductor pattern having four dipole arm regions separated by a narrow gap that has an open region, and wherein the conductor pattern has a passive conductor feature disposed within the open region.

Another aspect of the present disclosure involves a multiband antenna. The multiband antenna comprises a first folded dipole configured to operate at a first frequency band, the first folded dipole having a first conductor pattern; and a second folded dipole configured to operate at a second frequency band, the second folded dipole having a second conductor pattern, wherein the first conductor pattern and the second conductor pattern are substantially identical.

### BRIEF DESCRIPTION OF THE DRAWINGS

FIG. 1 illustrates a Mid Band (MB) folded dipole and a C-Band folded dipole deployed on an antenna reflector according to the disclosure.

FIG. 2 illustrates a conductor structure on a folded dipole according to the disclosure.

FIG. 3A illustrates a conductor pattern for an MB folded dipole of the disclosure, along with exemplary dimensions.

FIG. 3B illustrates the MB folded dipole of FIG. 3A, along with a passive radiator.

FIG. 4A illustrates a conductor pattern for a C-Band folded dipole of the disclosure, along with exemplary dimensions.

FIG. 4B illustrates the C-Band folded dipole of FIG. 4A, along with a passive radiator.

### DESCRIPTION OF EXEMPLARY EMBODIMENTS

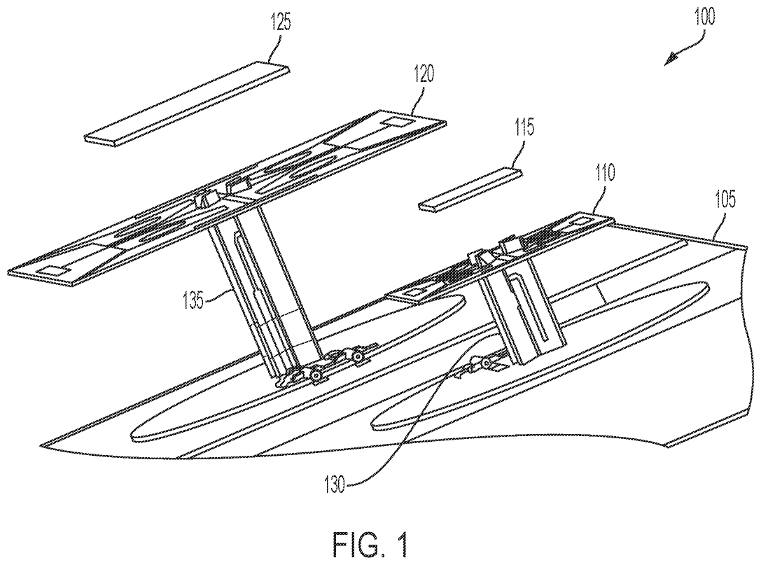

FIG. 1 illustrates an antenna array face 100 designed to operate in the Mid Band (1695-2690 MHz) as well as the C-Band (3.4-4.2 GHz). Array face 100 may have one or more MB folded dipoles 120 and one or more C-Band folded dipoles 110 according to the disclosure. Only one MB folded dipole 120 and C-Band folded dipole 110 is illustrated in FIG. 1, although it will be understood that array face 100 may have sub arrays of dipoles 120/110. Disposed above MB folded dipole 120 is an MB passive radiator 125, which is illustrated without a support structure for the purpose of illustration. Similarly, C-Band folded dipole 110 has a C-Band passive radiator 115 disposed above it, also with support structure omitted for the purpose of illustration. MB folded dipole 120 is mounted on an MB balun stem 135 that has circuitry for feeding RF (Radio Frequency) signals to MB folded dipole 120; and C-Band folded dipole 110 is mounted on a C-Band balun stem 130 that has circuitry for feeding RF signals to C-Band folded dipole 110. As illustrated, balun stems 135 and 130 are mechanically coupled to a reflector plate 105, which forms the base structure of antenna array face 100.

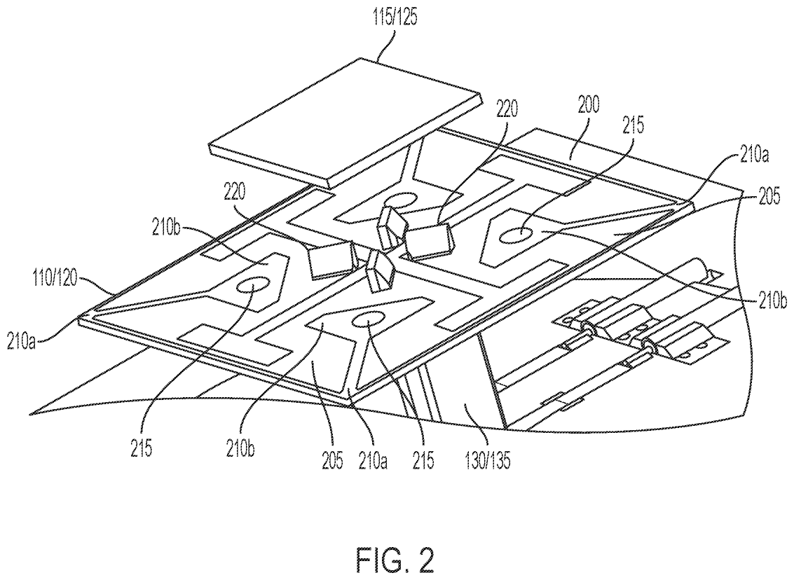

FIG. 2 illustrates a conductor pattern 200 of either MB folded dipole 120 or C-Band folded dipole 110 according to the disclosure. Conductor pattern 200 may be scalable such that the same pattern may be used on either folded dipole 120/110 but at different feature dimensions. Conductor pattern 200 includes four dipole arm regions 205 that surround a narrow gap 210a that may have an open region 210b, whereby the narrow gap 210a and open region 210b may define current flows within each of the four dipole arm regions 205 such that an RF current coupled via a solder joint 220 to a given dipole arm region 205 flows to/from adjacent solder joints 210 on either side, resulting in distinct RF signals being radiated in opposite directions within each dipole arm region 205, according to conventional operation of a folded dipole.

Disposed within each open region 210b is a passive conductor feature 215, illustrated as a circular conductive disk disposed on the same substrate (e.g., a Printed Circuit Board or PCB) as dipole arm regions 205. The presence of passive conductor feature 215 provides for tuning of the narrow gaps 210a and improving impeding matching for dipole arm regions 205.

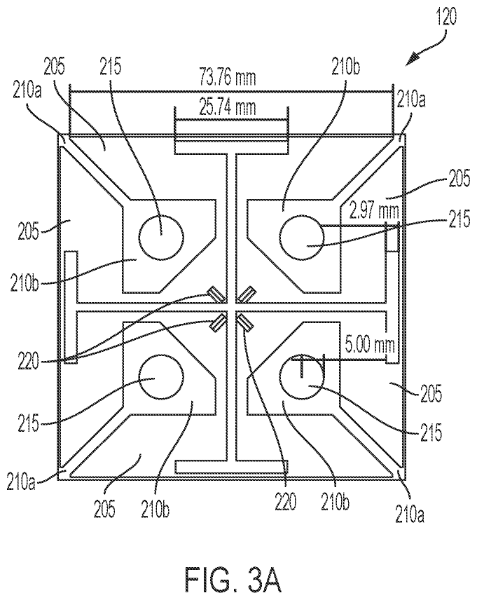

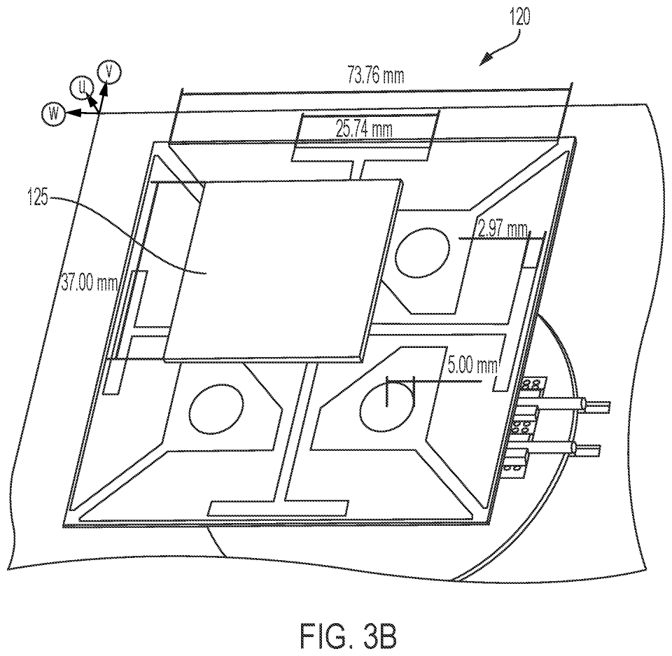

FIG. 3A illustrates a conductor pattern 200 for an MB folded dipole 120 of the disclosure, along with exemplary dimensions. Conductor pattern 200 of MB folded dipole 120 has the features described above with regard to FIG. 2, including four dipole arm regions 205 interrupted by narrow gaps 210a that open into a corresponding open region 210b; and a passive conductor features 215 disposed within each open region 210b; and solder joints 220 coupled to each dipole arm region 205.

FIG. 3B illustrates MB folded dipole 120 with passive radiator 125 disposed above it, along with exemplary dimensions.

Although passive conductor feature 215 has a circular shape, it will be understood that other shapes for passive conductor feature 215 are possible and within the scope of the disclosure.

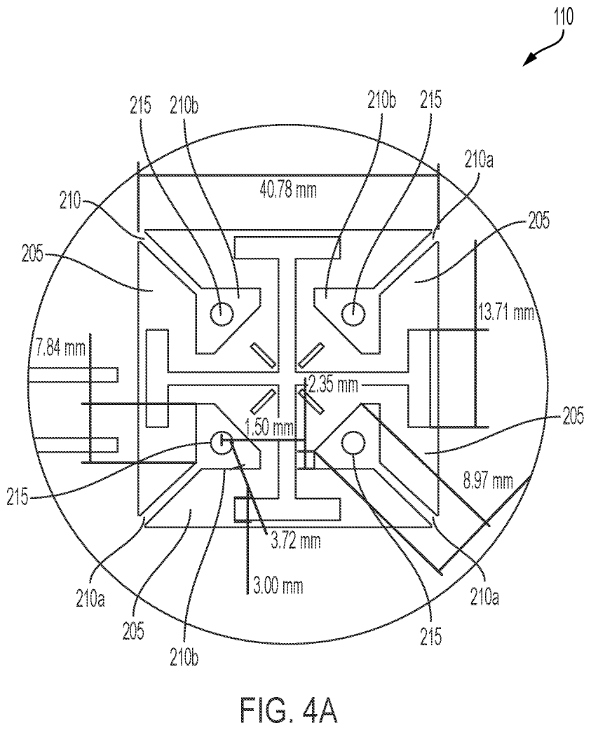

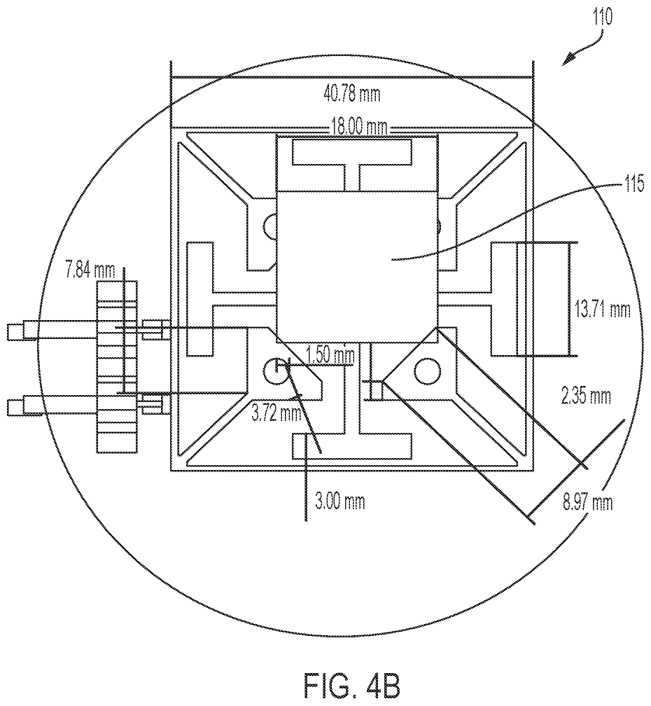

FIG. 4A illustrates a conductor pattern 200 for a C-Band folded dipole 110 of the disclosure, along with exemplary dimensions. Conductor pattern 200 of C-Band folded dipole 110 has the features described above with regard to FIG. 2, including four dipole arm regions 205 interrupted by narrow gaps 210a that open into a corresponding open region 210b; and a passive conductor features 215 disposed within each open region 210b; and solder joints 220 coupled to each dipole arm region 205.

FIG. 4B illustrates C-Band folded dipole 110 with passive radiator 115 disposed above it, along with exemplary dimensions.

Conductor pattern 200 for either MB folded dipole 120 or C-Band folded dipole 110 may be formed of copper, 1 oz (0.0347 mm) thick. Conductor pattern 200 may be formed on a substrate, 30 thou (0.762 mm) thick having a dielectric constant of 2.2. It will be understood that these materials and thicknesses are exemplary and that variations are possible and within the scope of the disclosure.

1. A folded dipole, comprising:
a substrate; and
a conductor pattern disposed on the substrate, the conductor pattern having four dipole arm regions separated by a narrow gap that has an open region, and wherein the conductor pattern has a passive conductor feature disposed within the open region.

2. The folded dipole of claim 1, further comprising a passive radiator disposed above the conductor pattern.

3. The folded dipole of claim 1, wherein the conductor pattern is scaleable.

4. A multiband antenna comprising:
a first folded dipole configured to operate at a first frequency band, the first folded dipole having a first conductor pattern; and
a second folded dipole configured to operate at a second frequency band, the second folded dipole having a second conductor pattern,
wherein the first conductor pattern and the second conductor pattern are substantially identical.

5. The multiband antenna of claim 4, wherein the first conductor pattern comprises four first dipole arm regions separated by a first narrow gap that has a first open region, and wherein the first conductor pattern has a first passive conductor feature disposed within the first open region.

6. The multiband antenna of claim 4, wherein the second conductor pattern comprises four second dipole arm regions separated by a second narrow gap that has a second open region, and wherein the second conductor pattern has a second passive conductor feature disposed within the second open region.

7. The multiband antenna of claim 4, wherein the first conductor pattern is scaleable.

8. The multiband antenna of claim 4, wherein the second conductor pattern is scaleable.
